(19) United States
(12) Patent Application Publication
(10) Pub. No.: US 2019/0198977 A1
(43) Pub. Date: Jun. 27, 2019

(54) TUNABLE ANTENNA AND MOBILE PHONE

(71) Applicant: ZTE Corporation, Shenzhen (CN)

(72) Inventor: Qun LI, Shenzhen (CN)

(21) Appl. No.: 16/099,027

(22) PCT Filed: Sep. 13, 2016
(86) PCT No.: PCT/CN2016/098869

§ 371 Date: Nov. 5, 2018

(30) Foreign Application Priority Data
May 18, 2016 (CN) 201610333016.3

(51) Int. Cl. H01Q 1/24; H01Q 1/22; H01Q 5/378; H01Q 1/52

(52) U.S. Cl. CPC H01Q 1/243; H01Q 1/52; H01Q 5/378; H01Q 1/2283

(57) ABSTRACT

Provided are a tunable antenna and a mobile phone equipped with the tunable antenna, the tunable antenna including a mainboard and an antenna body, where a first connecting structure and a second connecting structure are configured between the antenna body and the mainboard, such that when a USB cable is not inserted, the antenna body is connected with the mainboard through the first connecting structure, and when the USB cable is inserted, the antenna body is connected with the mainboard through the second connecting structure

### TECHNICAL FIELD

The application relates, but is not limited, to the field of radio technology.

### BACKGROUND

In a related technology, a USB device is arranged at a bottom in more and more mobile phone projects, and at the same time an antenna of the mobile phone is also arranged at the bottom generally. Along with the extensive application of a USB TYPE-C interface, impact generated by a USB on design and performance of the antenna which is arranged adjacent to the USB becomes greater. In order to optimize setting of an antenna module and a USB module, a common practice at present is to take an external metal part of the USB as one part of the antenna, or one part of a radiator, or a carrier connecting the antenna on a housing with the antenna on a Printed Circuit Board (PCB). As an alternative, the antenna may be arranged to keep away from the USB. In consideration of a limited space where the antenna is located and characteristic that the antenna performance is sensitive to a distance between the antenna and the USB, the above setting would neither achieve the effect of enabling the antenna and the USB to be far away from each other, nor effectively solve the problem that the antenna performance is declined as a result of insertion of USB.

Relevant optimization solutions include: tuning the antenna or introducing a sensor to judge that the mobile phone which is close to a head of a person is in a calling status, or in a handheld status or in a standby mode. Antenna parameters corresponding to these statuses are configured respectively, and corresponding parameters are called when the sensor detects the corresponding status. During practical operations, the antenna is tuned on the basis of the condition that no USB cable is inserted. When a USB cable is inserted, a standing-wave ratio of the antenna changes greatly, and the antenna performance changes as well. Due to deviation of the standing-wave ratio of the antenna and digital interference occurring when the USB cable works, the antenna performance declines sharply, and actual call quality of a user is greatly influenced.

### SUMMARY

The following is an overview of subject matter described in the present disclosure in detail. The overview is not intended to limit the scope of protection of claims.

Some embodiments of the application provide a tunable antenna which may maintain the status and performance of the antenna stable.

Some embodiments of the application provide a tunable antenna which includes a mainboard and an antenna body.

A first connecting structure and a second connecting structure are configured between the antenna body and the mainboard. When a USB cable is not inserted, the antenna body is connected with the mainboard through the first connecting structure. When the USB cable is inserted, the antenna body is connected with the mainboard through the second connecting structure.

In at least one exemplary embodiment, the mainboard is provided with a control circuit and a tunable switching circuit. The control circuit is configured to control switching from the first connecting structure to the second connecting structure through the tunable switching circuit when insertion of the USB cable is detected.

In at least one exemplary embodiment, the antenna body is connected with a radio frequency channel of the mainboard through a signal line.

In at least one exemplary embodiment, there are two access statuses between a switch and a port of the tunable switching circuit, respectively being a first access status and a second access status. The first access status is configured as an initial connecting status between the switch and the port.

In at least one exemplary embodiment, the first connecting structure is configured to connect the antenna body with the tunable switching circuit through a ground signal, the tunable switching circuit being configured to be in the first access status. The second connecting structure is configured to connect the antenna body with the tunable switching circuit through a ground signal, the tunable switching circuit being configured to be in the second access status.

In at least one exemplary embodiment, the tunable switching circuit has at least two ports, and the at least two ports have different values. A port in connection with the switch in the first access status is different from a port in connection with the switch in the second access status.

In at least one exemplary embodiment, the antenna body is provided with a first ground signal and a second ground signal.

In at least one exemplary embodiment, the first connecting structure is configured to connect the antenna body with the tunable switching circuit through a first ground signal, and to connect the antenna body with a ground wire of the mainboard through the second ground signal. The second connecting structure is configured to disconnect the first ground signal from the tunable switching circuit, and to connect the antenna body with the ground wire of the mainboard through the second ground signal.

Some embodiments of the application provide a mobile phone, which includes a tunable antenna. The tunable antenna mentioned in any one of the above solutions may be used.

Through optimized arrangement of the first connecting structure and the second connecting structure between the antenna body and the mainboard, the solution in some embodiments of the application may eliminate deviation of a standing-wave ratio of the antenna body resulted from insertion of the USB cable and maintain the status and performance of the antenna stable, and accordingly the antenna body may have good radiation efficiency regardless of whether the USB cable is inserted.

Other characteristics and advantages of the embodiments of the present disclosure will be clarified in the subsequent description and become apparent partially in the description, or may be known through implementation of the embodiments of the present disclosure. The purpose and other advantages of the embodiments of the present disclosure may be achieved and acquired through structures particularly pointed out in the description, claims and drawings.

Other aspects may be understood after reading and comprehending drawings and detailed description.

### BRIEF DESCRIPTION OF THE DRAWINGS

FIG. 1 is a first structure diagram of an embodiment of the present disclosure.

FIG. 2 is a second structure diagram of an embodiment of the present disclosure.

### DETAILED DESCRIPTION OF THE EMBODIMENTS

The embodiments of the present disclosure will be described below in combination with drawings. It is to be noted that the embodiments in the application and various methods in the embodiments may be combined together under the circumstance that no conflict occurs.

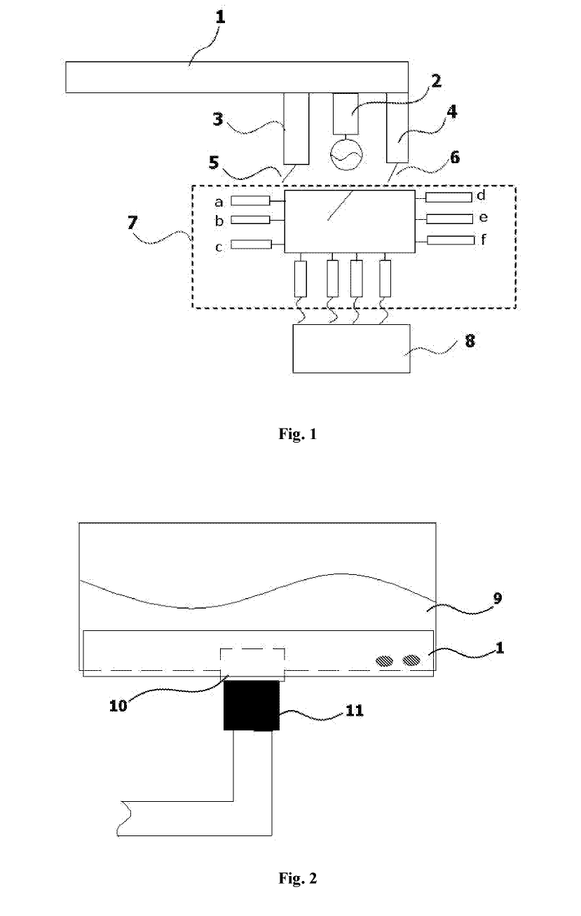

Referring to FIG. 1 and FIG. 2, the embodiments of the present disclosure provide a tunable antenna, in which a mainboard 9 and an antenna body 1 may be configured. A first connecting structure and a second connecting structure are configured between the antenna body 1 and the mainboard 9. When a USB cable is not inserted, the antenna body 1 is connected with the mainboard 9 through the first connecting structure. When the USB cable is inserted, the antenna body 1 is connected with the mainboard 9 through the second connecting structure. As an exemplary implementation, the mainboard 9 is provided with a control circuit 8 and a tunable switching circuit 7. The control circuit 8 is configured to control switching from the first connecting structure to the second connecting structure through the tunable switching circuit 7 when insertion of the USB cable is detected.

In practical operations, when a cable 11 is inserted to a port of a USB10, the control circuit 8 may detect the insertion timely and control the connecting structure between the antenna body 1 and the mainboard 9 to correspondingly switch so as to eliminate deviation of a standing-wave ratio of the antenna body resulted from insertion of the USB cable. Through the above operations, status and performance of the antenna may be maintained stable, and the antenna body 1 may have good radiation efficiency regardless of whether the USB cable is inserted. As an exemplary implementation, the antenna body 1 may be connected with a radio frequency channel of the mainboard 9 through a signal line 2.

In order to explain switching of the above connecting structures in detail, some embodiments of the application put forward the following technical solution. There are two access statuses between a switch and a port of the tunable switching circuit 7, respectively being a first access status and a second access status. The first access status serves as an initial connecting status between the switch and the port. Accordingly, the first connecting structure is configured to connect the antenna body 1 with the tunable switching circuit 7 through a ground signal, the tunable switching circuit 7 being configured to be in the first access status. The second connecting structure is configured to connect the antenna body 1 with the tunable switching circuit 7 through a ground signal, the tunable switching circuit 7 being configured to be in the second access status.

In practical operations, those skilled in the art may assign different values to various ports in the tunable switching circuit 7, and connect different ports through the switch in the tunable switching circuit 7, thereby achieving switching between different statuses and accordingly achieving deviation correction of the standing-wave ratio of the antenna when the USB cable is inserted.

In order to explain switching of the above connecting structures in detail, some embodiments of the application put forward the following technical solution. The antenna body 1 is provided with a first ground signal 3 and a second ground signal 4. The first connecting structure is configured as follows: the antenna body 1 is connected with the tunable switching circuit 7 through the first ground signal 3, and the antenna body 1 is connected with a ground wire of the mainboard 9 through the second ground signal 4. The second connecting structure is configured as follows: the first ground signal 3 is disconnected from the tunable switching circuit 7, and the antenna body 1 is connected with the ground wire of the mainboard 9 through the second ground signal 4.

In practical operations, those skilled in the art may tune the antenna correspondingly through switching connection of two ground signals of the antenna body 1 so as to achieve deviation correction of the standing-wave ratio of the antenna when the USB cable is inserted.

Exemplary embodiments are given below to further explain the solution in detail.

### First Exemplary Embodiment

In the status that the USB is not inserted, the antenna body 1 is connected with the radio frequency channel of the mainboard 9 through the signal line 2, and the first ground signal 3 is connected with the tunable switching circuit 7 through a wire 5. A single-pole multi-throw switch is configured in the tunable switching circuit 7 and is switched to a port a. A wire 6 may be or may not be provided in this embodiment. If available, the wire 6 is grounded all the time. The wire 5 is fixedly connected with one port of the tunable switching circuit 7, and the port may be connected with one of ports a, b, c, d, e and f by the single-pole multi-throw switch.

When the control circuit 8 detects that the USB cable 11 is inserted, the switch in the tunable switching circuit 7 breaks up the connection with the port a, and is switched to the port b to form a connection with the port b. The port a and the port b are assigned with different values. The value of the port may be embodied as capacitance or inductance, and is related to the antenna status, design method and relative positions in a layout of the antenna and the USB, and the specific value may be determined by tuning a return loss (RL) of the antenna body 1.

In the status that the USB is not inserted, the antenna body 1 may work in different frequency bands, such as LTEB5, LTEB2 and LTEB12. The first ground signal 3 of the antenna is controlled, by the switch, to be in connection with different ports in different frequency bands. For example, when the antenna body 1 works in the LTEB5, the first ground signal 3 is connected with the port a of the tunable switching circuit 7. When the antenna body 1 works in the LTEB12, the first ground signal 3 is connected with the port b. Connection of the first ground signal 3 may also be switched to the ports d and e when the USB cable is inserted. Those skilled in the art may assign corresponding value to each port and select corresponding switching port according to the above revelation of the exemplary technical solution and the actual tuning condition.

### Second Exemplary Embodiment

In the status that the USB is not inserted, the antenna body 1 is connected with the radio frequency channel on the mainboard 9 through the signal line 2, the first ground signal 3 is connected with the tunable switching circuit 7 through a wire 3, the second ground signal 4 is connected with the ground wire on the mainboard 9 through a wire 6, and the first ground signal 3 and the second ground signal 4 are both in the working status. The single-pole multi-throw switch is configured in the tunable switching circuit 7 and is switched to the port a.

When the control circuit 8 detects that the USB cable is inserted, the switch of the tunable switching circuit 7 is disconnected from the port a and disconnected from the first ground signal 3 of the antenna body 1. The first ground signal 3 is in a non-working status, while the second ground signal 4 is in a working status. Based on the above status change, the antenna body 1 is tuned in advance so as to achieve deviation correction of the standing-wave ratio of the antenna when the USB cable is inserted.

Through optimized arrangement of the first connecting structure and the second connecting structure between the antenna body and the mainboard, some embodiments of the application may eliminate deviation of the standing-wave ratio of the antenna body resulted from insertion of the USB cable and maintain the status and performance of the antenna stable, and accordingly the antenna body may have good radiation efficiency regardless of whether the USB cable is inserted.

Some embodiments of the application provide a mobile phone including a tunable antenna mentioned in any of the above solutions. The mobile phone has multiple working frequency bands, and a port or ports in connection with the switch in the first access status and/or the second access status corresponding to different working frequency bands may be different.

Those skilled in the art should understand that although the modes of implementation are disclosed by the embodiments of the present disclosure above, the above contents are the modes of implementation taken to facilitate understanding of the embodiments of the present disclosure rather than limit the embodiments of the present disclosure. Any of those skilled in the art of the embodiments of the present disclosure may make any modifications and changes on implementation and detail, without departing from the principle and scope provided by the embodiments of the present disclosure. However, the scope of patent protection of the embodiments of the present disclosure shall be subject to the scope of protection of the claims.

### INDUSTRIAL APPLICABILITY

Through the solutions of some embodiments of the present disclosure, a first connecting structure and a second connecting structure are configured and switchable between an antenna body and a mainboard. The deviation of a standing-wave ratio of the antenna body resulted from insertion of the USB cable may be eliminated, status and performance of the antenna may be maintained stable, and accordingly the antenna body may have good radiation efficiency regardless of whether the USB cable is inserted.

1. A tunable antenna, comprising a mainboard and an antenna body, wherein
a first connecting structure and a second connecting structure are configured between the antenna body and the mainboard; when a USB cable is not inserted, the antenna body is connected with the mainboard through the first connecting structure; and when the USB cable is inserted, the antenna body is connected with the mainboard through the second connecting structure.

2. The tunable antenna as claimed in claim 1, wherein
the mainboard is provided with a control circuit and a tunable switching circuit; the control circuit is configured to control switching from the first connecting structure to the second connecting structure through the tunable switching circuit when insertion of the USB cable is detected.

3. The tunable antenna as claimed in claim 2, wherein
the antenna body is connected with a radio frequency channel of the mainboard through a signal line.

4. The tunable antenna as claimed in claim 2, wherein
there are two access statuses between a switch and a port of the tunable switching circuit, respectively being a first access status and a second access status; and the first access status is configured as an initial connecting status between the switch and the port.

5. The tunable antenna as claimed in claim 4, wherein
the first connecting structure is configured to connect the antenna body with the tunable switching circuit through a ground signal, the tunable switching circuit being configured to be in the first access status; and the second connecting structure is configured to connect the antenna body with the tunable switching circuit through a ground signal, the tunable switching circuit being configured to be in the second access status.

6. The tunable antenna as claimed in claim 5, wherein
the tunable switching circuit has at least two ports, and the at least two ports have different values; and a port in connection with the switch in the first access status is different from a port in connection with the switch in the second access status.

7. The tunable antenna as claimed in claim 2, wherein
the antenna body is provided with a first ground signal and a second ground signal.

8. The tunable antenna as claimed in claim 7, wherein
the first connecting structure is configured to connect the antenna body with the tunable switching circuit through the first ground signal, and to connect the antenna body with a ground wire of the mainboard through the second ground signal; and the second connecting structure is configured to disconnect the first ground signal from the tunable switching circuit, and to connect the antenna body with the ground wire of the mainboard through the second ground signal.

9. A mobile phone, comprising a tunable antenna as claimed in claim 1.

10. A mobile phone, comprising a tunable antenna as claimed in claim 6, the mobile phone has multiple working frequency bands, and ports in connection with a switch in a first access status and/or a second access status corresponding to different working frequency bands are different.

11. The tunable antenna as claimed in claim 2, wherein the control circuit is further configured to detect the insertion of the USB cable.

12. The tunable antenna as claimed in claim 2, wherein the tunable switching circuit is a single-pole multi-throw switch.

13. The tunable antenna as claimed in claim 6, wherein the values of the at least two ports are embodied as capacitance or inductance.

14. A mobile phone, comprising a tunable antenna as claimed in claim 2.

15. A mobile phone, comprising a tunable antenna as claimed in claim 3.

16. A mobile phone, comprising a tunable antenna as claimed in claim 4.

17. A mobile phone, comprising a tunable antenna as claimed in claim 5.

18. A mobile phone, comprising a tunable antenna as claimed in claim 6.

19. A mobile phone, comprising a tunable antenna as claimed in claim 7.

20. A mobile phone, comprising a tunable antenna as claimed in claim 8.
